(19) United States
(12) Patent Application Publication
(10) Pub. No.: US 2006/0013309 A1
(43) Pub. Date: Jan. 19, 2006

(54) Video encoding and decoding methods and video encoder and decoder

(75) Inventors: Ho-jin Ha, Seoul (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/181,803

(22) Filed: Jul. 15, 2005

Related U.S. Application Data
(60) Provisional application No. 60/587,905, filed on Jul. 15, 2004.

(30) Foreign Application Priority Data
Aug. 11, 2004 (KR) 10-2004-0063198
Dec. 31, 2004 (KR) 10-2004-0118021

(51) Int. Cl. H04N 11/02; H04N 11/04; H04N 7/12; H04B 1/66

(52) U.S. Cl. 375/240.16; 375/240.03; 375/240.08; 375/240.24; 375/240.12

(57) ABSTRACT

Video coding and decoding methods capable of providing motion scalability and video encoder and decoder are provided. The video coding method includes estimating a base layer motion vector and an enhancement layer motion vector for each block in a video frame, removing temporal redundancies in the video frame using the enhancement layer motion vectors, spatially transforming the video frame in which the temporal redundancies have been removed and quantizing the spatially transformed video frame to obtain texture information, selecting one of the estimated base layer motion vector and the estimated enhancement layer motion vector for each block, and generating a bitstream containing the motion vector selected for each block and the texture information.

### CROSS-REFERENCE TO RELATED APPLICATIONS

This application claims priority from Korean Patent Application No. 10-2004-0063198 filed on Aug. 11, 2004 in the Korean Intellectual Property Office, Korean Patent Application No. 10-2004-0118021 filed on Dec. 31, 2004 in the Korean Intellectual Property Office, and U.S. Provisional Patent Application No. 60/587,905 filed on Jul. 15, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to video coding, and more particularly, to video coding providing motion scalability.

2. Description of the Related Art

With the development of information communication technology including the Internet, video communication as well as text and voice communication has rapidly increased. Conventional text communication cannot satisfy various user demands, and thus multimedia services that can provide various types of information such as text, pictures, and music have increased. Multimedia data requires a large capacity storage media and a wide bandwidth for transmission since the amount of multimedia data is usually large relative to other types of data. Accordingly, a compression coding method is required for transmitting multimedia data including text, video, and audio. For example, a 24-bit true color image having a resolution of 640*480 needs a capacity of 640*480*24 bits, i.e., data of about 7.37 Mbits, per frame. When an image such as this is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

In such a compression coding method, a basic principle of data compression lies in removing data redundancy. Data redundancy is typically defined as: (i) spatial redundancy in which the same color or object is repeated in an image; (ii) temporal redundancy in which there is little change between adjacent frames in a moving image or the same sound is repeated in audio; or (iii) mental visual redundancy taking into account human eyesight and perception dull to high frequency. Data can be compressed by removing such data redundancy. Data compression can largely be classified into lossy/lossless compression, according to whether source data is lost, intraframe/interframe compression, according to whether individual frames are compressed independently, and symmetric/asymmetric compression, according to whether time required for compression is the same as time required for recovery. In addition, data compression is defined as real-time compression when a compression/recovery time delay does not exceed 50 ms and as scalable compression when frames have different resolutions. As examples, for text or medical data, lossless compression is usually used. For multimedia data, lossy compression is usually used.

FIG. 1 is a block diagram of a conventional video encoder 100.

Referring to FIG. 1, the conventional video encoder 100 includes a motion estimator 110 estimating motion between video frames, a motion compensator 120 removing temporal redundancies within video frames, a spatial transformer 130 performing spatial transform to remove spatial redundancies, a quantizer 140 quantizing the frames in which spatial redundancies have been removed, a motion information encoder 160, and a bitstream generator 150 generating a bitstream.

More specifically, the motion estimator 110 finds motion vectors to be used in removing temporal redundancies by compensating the motion of a current frame. The motion vector is defined as a displacement from the best-matching block in a reference frame with respect to a block in a current frame, which will be described with reference to FIG. 2. Although the original video frame may be used as the reference frame, many of known video coding techniques use a reconstructed frame obtained by decoding the original video frame as the reference frame.

The motion compensator 120 uses the motion vectors calculated by the motion estimator 110 to remove the temporal redundancies present in the current frame. To this end, the motion compensator 120 uses a reference frame and motion vectors to generate a predicted frame and compares the current frame with the predicted frame to thereby generate a residual frame.

The spatial transformer 130 spatially transforms residual frames to obtain transform coefficients. The most commonly used spatial transform algorithm is the Discrete Cosine Transform (DCT). Recently, a wavelet transform has been widely adopted.

The quantizer 140 quantizes the transform coefficients obtained through the spatial transformer 130. A quantization strength is determined according to a bit rate.

The motion information encoder 160 encodes the motion vectors calculated by the motion estimator 110 in order to reduce the amount of data and generates motion information that is contained in a bitstream.

The bitstream generator 150 generates a bitstream containing the quantized transform coefficients and the encoded motion vectors. While not shown in FIG. 1, in conventional video coding schemes such as MPEG-2, MPEG-4, and H.264, the quantized transform coefficients are not directly inserted into the bitstream. Instead, texture information created after scanning, scaling, and entropy coding is contained in the bitstream.

FIG. 2 illustrates a conventional motion estimation process and a temporal mode used during motion estimation.

The motion estimation process is basically performed using a block-matching algorithm. A block in a reference frame is moved within a search area to be compared with a block in a current frame and a difference between the two blocks and a cost for coding a motion vector are calculated. A block in a reference frame minimizing the cost is selected as the best-matching reference block. While a full search guarantees the best performance in motion estimation, the process requires excessive computational load. Three step search or hierarchical variable size block matching (HVSBM) is commonly used for motion estimation in currently widely used video coding. There are three temporal interframe modes used in motion estimation: forward, backward, and bi-directional. A conventional video coding scheme uses the inter-frame prediction modes as well as an intraframe prediction mode using information from the current frame.

A scalable video coding scheme using motion compensation to remove temporal redundancies provides high video compression efficiency at a sufficient bit rate. However, the conventional scheme gives poor compression efficiency at a low bit rate since it reduces the number of bits being allocated to texture information contained in a bitstream generated by video coding while maintaining the same number of bits being allocated to motion information contained therein. When the conventional video coding scheme is performed at a very low bit rate, the resulting bitstream may contain little texture information, or, in the extreme case, only motion information. For this reason, the conventional video coding in which motion information is difficult to reduce suffers significant degradation in video quality in a low bit rate. Therefore, there is a need for an algorithm designed to adjust the amount of bits to be allocated to motion information in a bitstream.

### SUMMARY OF THE INVENTION

The present invention provides video encoding and decoding methods capable of adjusting the amount of bits being allocated to motion information and video encoder and decoder.

According to an aspect of the present invention, there is provided a video coding method including estimating a base layer motion vector and an enhancement layer motion vector for each block in a video frame; removing temporal redundancies in the video frame using the enhancement layer motion vectors; spatially transforming the video frame in which the temporal redundancies have been removed and quantizing the spatially transformed video frame to obtain texture information; selecting one of the estimated base layer motion vector and the estimated enhancement layer motion vector for each block; and generating a bitstream containing the motion vector selected for each block and the texture information.

According to another aspect of the present invention, there is provided a video coding method including estimating a base layer motion vector and an enhancement layer motion vector for ach block in a video frame, removing temporal redundancies in the video frame using the enhancement layer motion vector, spatially transforming the video frame in which the temporal redundancies have been removed and quantizing the spatially transformed video frame to obtain texture information, and generating a bitstream containing the estimated base layer motion vector, a residual motion vector being the difference between the estimated base layer motion vector and the estimated enhancement layer motion vector, and the texture information for each block.

According to still another aspect of the present invention, there is provided a video encoder including a motion estimator estimating a base layer motion vector and an enhancement layer motion vector for each block in a video frame, a motion compensator removing temporal redundancies in the video frame using the enhancement layer motion vectors, a spatial transformer spatially transforming the video frame in which the temporal redundancies have been removed, a quantizer quantizing the spatially transformed video frame to obtain texture information, a motion vector selector selecting one of the estimated base layer motion vector and the estimated enhancement layer motion vector for each block, and a bitstream generator generating a bitstream containing the motion vector selected for each block and the texture information.

According to a further aspect of the present invention, there is provided a video encoder including a motion estimator estimating a base layer motion vector and an enhancement layer motion vector for each block in a video frame, a motion compensator removing temporal redundancies in the video frame using the enhancement layer motion vectors, a spatial transformer spatially transforming the video frame in which the temporal redundancies have been removed, a quantizer quantizing the spatially transformed video frame to obtain texture information, and a bitstream generator generating a bitstream containing the estimated base layer motion vector, a residual motion vector being the difference between the estimated base layer motion vector and the estimated enhancement layer motion vector, and the texture information for each block.

According to yet another aspect of the present invention, there is provided a predecoding method including receiving a bitstream containing a base layer motion vector and a residual motion vector being the difference between the base layer motion vector and an enhancement layer motion vector for each block, and texture information obtained by encoding the video frame, and truncating at least a part of the residual motion vectors.

According to another aspect of the present invention, there is provided a video decoding method including interpreting an input bitstream and obtaining texture information and motion information containing base layer motion vectors and enhancement layer motion vectors; readjusting the base layer motion vectors; performing inverse quantization and inverse spatial transform on the texture information to obtain frames in which temporal redundancies are removed; and performing inverse motion compensation on the frames in which the temporal redundancies have been removed using the base layer motion vectors which have been readjusted and the enhancement layer motion vectors.

According to still another aspect of the present invention, there is provided a video decoding method including interpreting an input bitstream and obtaining texture information and motion information containing base layer motion vectors and residual motion vectors, merging a base layer motion vector with a residual motion vector for each of blocks having both the base layer motion vector and the residual motion vector and obtaining merged motion vectors, performing inverse quantization and inverse spatial transform on the texture information and obtaining frames in which temporal redundancies are removed, and performing inverse motion compensation on the frames in which the temporal redundancies have been removed using the merged motion vectors and the unmerged base layer motion vectors.

According to a further aspect of the present invention, there is provided a video decoder including a bitstream interpreter interpreting an input bitstream and obtaining texture information and motion information containing base layer motion vectors and enhancement layer motion vectors, a motion vector readjuster readjusting the base layer motion vectors, an inverse quantizer performing inverse quantization on the texture information, an inverse spatial transformer performing inverse spatial transform on the inversely quantized texture information to obtain frames in which temporal redundancies are removed, and an inverse motion compensator performing inverse motion compensation on the frames in which the temporal redundancies have been removed using the readjusted base layer motion vectors and the enhancement layer motion vectors and reconstructing a video frame.

According to yet another aspect of the present invention, there is provided a video decoder including a bitstream interpreter interpreting an input bitstream and obtaining texture information and motion information containing base layer motion vectors and residual motion vectors, a motion vector merger merging a base layer motion vector with a residual motion vector for each of blocks having both the base layer motion vector and the residual motion vector and obtaining merged motion vectors, an inverse quantizer performing inverse quantization on the texture information, an inverse spatial transformer performing inverse spatial transform on the inversely quantized texture information and obtaining frames in which temporal redundancies are removed, and an inverse motion compensator performing inverse motion compensation on the frames in which the temporal redundancies have been removed using the merged motion vectors and the unmerged base layer motion vectors.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a conventional video encoder;

FIG. 2 illustrates a conventional motion estimation process and temporal modes;

FIG. 3 is a block diagram of a video encoder according to a first exemplary embodiment of the present invention;

FIGS. 4 and 5 are block diagrams of video encoders according to second and third exemplary embodiments of the present invention, respectively;

FIG. 6 illustrates a motion estimation process according to an exemplary embodiment of the present invention;

FIG. 7 illustrates block modes according to an exemplary embodiment of the present invention;

FIG. 8 illustrates examples of a frame with different percentages of enhancement layers according to an exemplary embodiment of the present invention;

FIG. 9 is a block diagram of a video decoder according to a first exemplary embodiment of the present invention;

FIGS. 10 and 11 are block diagrams of video decoders according to second and third exemplary embodiments of the present invention, respectively;

FIG. 12 illustrates a video service environment according to an exemplary embodiment of the present invention;

FIG. 13 illustrates the structure of a bitstream according to an exemplary embodiment of the present invention; and

FIG. 14 is a graph illustrating changes in video qualities when an enhancement layer motion vector and a base layer motion vector are used.

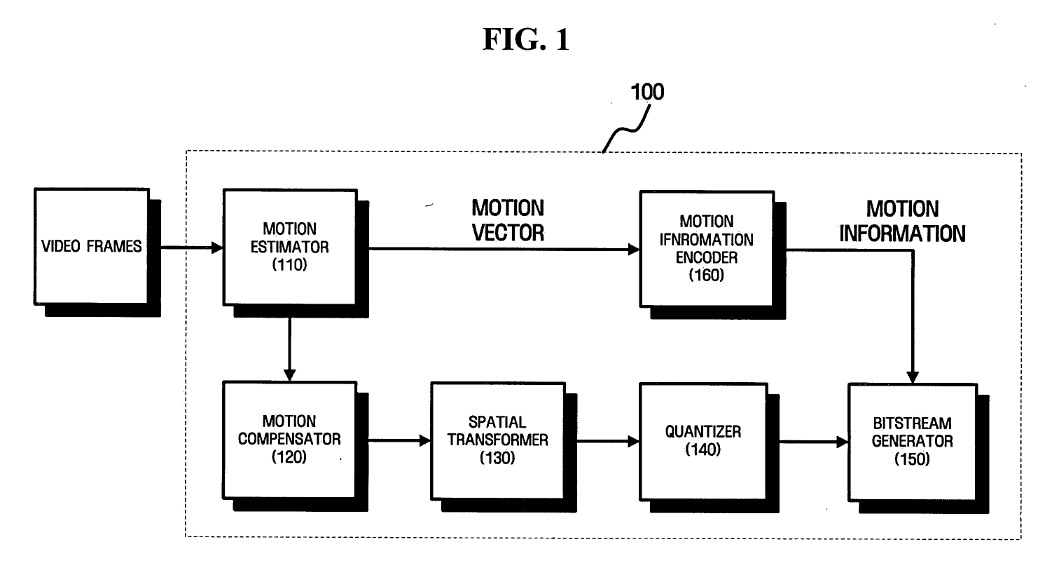

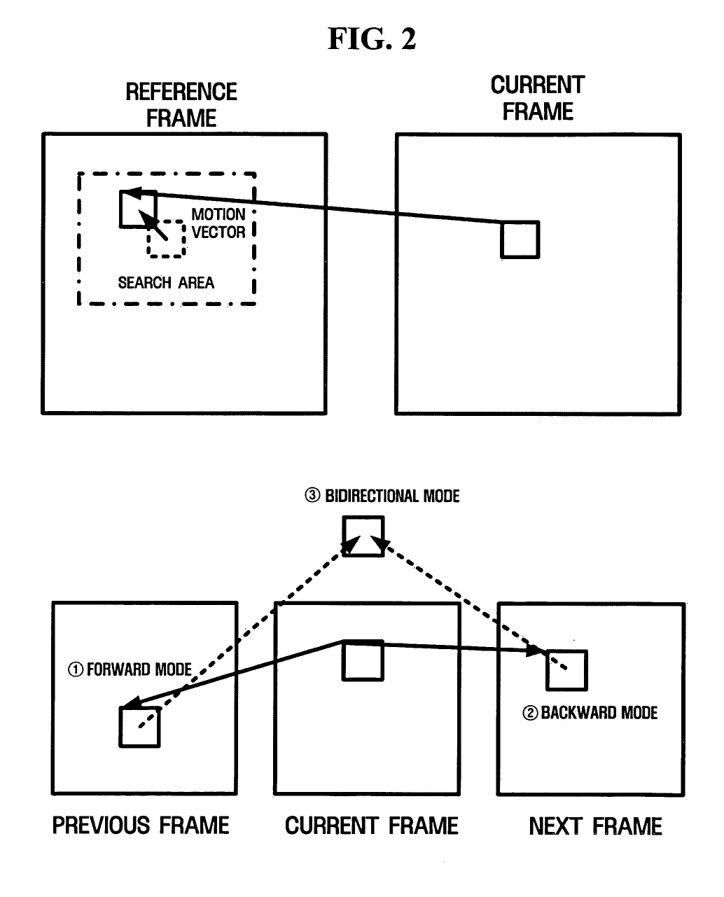

### DETAILED DESCRIPTION OF EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

The present invention presents a video coding scheme designed to adjust the amount of bits being allocated to motion vectors (motion information) and can be applied to both open-loop video coding using an original video frame as a reference frame and closed-loop video coding using a reconstructed frame as a reference frame. Since closed-loop video coding uses a reconstructed frame obtained by performing inverse quantization, inverse transform, and motion compensation on quantized transform coefficients as a reference frame, a closed-loop video encoder includes several components for video decoding such as an inverse quantizer and an inverse spatial transformer, unlike an open-loop video encoder. While the present invention will be described with reference to exemplary embodiments using open-loop scalable video coding, closed-loop video coding may be used as well.

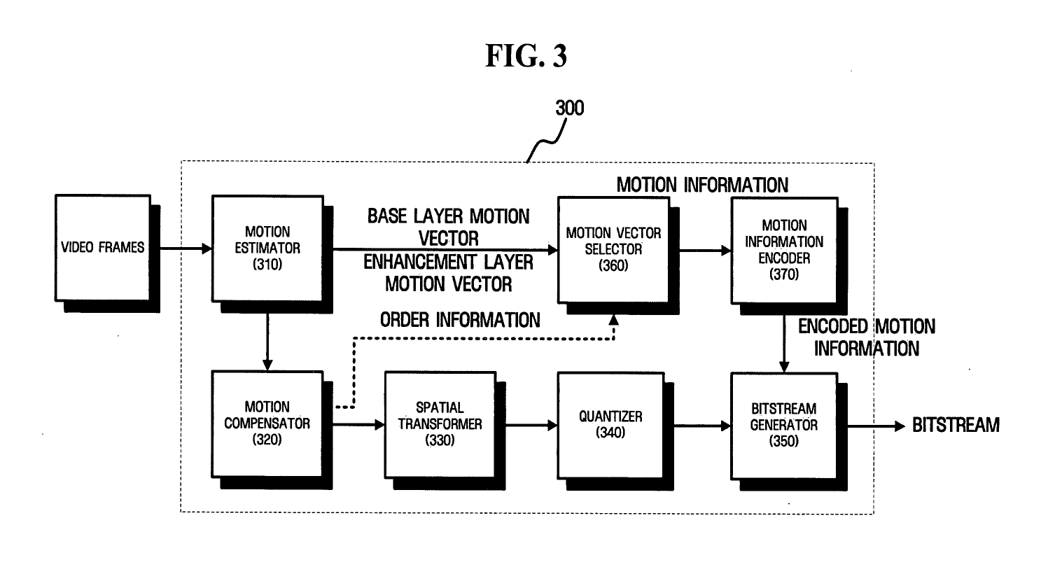

FIG. 3 is a block diagram of a video encoder 300 according to a first exemplary embodiment of the present invention.

Referring to FIG. 3, the video encoder 300 according to the first exemplary embodiment of the present invention includes a motion estimator 310, a motion compensator 320, a spatial transformer 330, a quantizer 340, a bitstream generator 350, a motion vector selector 360, and a motion information encoder 370.

The motion estimator 310 estimates motion between each block in a current frame and a block in one reference frame or blocks in two reference frames corresponding to the block in the current frame. The displacement between positions of each block in the current frame and a corresponding block in the reference frame is defined as a motion vector.

Since a motion estimation process finding a motion vector requires a large amount of computations, various techniques are developed to reduce the amount of computations to estimate motion. Three step search or two dimensional (2D) logarithm search is designed to reduce the amount of calculations by reducing the number of search points for each motion vector estimation. An adaptive/predictive search is a method by which a motion vector for a block in a current frame is predicted from a motion vector for a block in the previous frame in order to reduce the amount of calculations required for motion estimation. HVSBM is an algorithm in which a frame having an original resolution is downsampled to obtain low resolution frames and a motion vector found at the lowest resolution is used to find motion vectors having increasingly higher resolutions. Another approach to reducing the amount of calculations needed for motion estimation is to replace a function of calculating a cost of block matching with a simple one.

The motion estimator 310 in the present exemplary embodiment performs a process of finding a base layer motion vector and a process of finding an enhancement layer motion vector. That is, the motion estimator 310 finds the base layer motion vector and then readjusts the base layer motion vector to find the enhancement layer motion vector. The process of finding motion vectors of a base layer and an enhancement layer may be performed by various motion estimation algorithms. In the present exemplary embodiment, the process of finding the motion vector of a base layer or of finding the motion vectors of the base layer and the enhancement layer is performed using HVSBM since a motion vector obtained using HVSBM has characteristics that are consistent with the characteristics of a motion vector for an adjacent block. Furthermore, the enhancement layer motion vector is found within a search area smaller than a search area in which the base layer motion vector is obtained. In other words, the enhancement layer motion vector is obtained by readjusting the based layer motion vector already estimated.

The motion compensator 320 obtains order information by performing motion compensation using the base layer motion vector (hereinafter called “base layer motion compensation”) separately from motion compensation using the enhancement layer motion vector (hereinafter called “enhancement layer motion compensation”). The motion compensator 320 then provides frames in which temporal redundancies have been removed by enhancement layer motion compensation to the spatial transformer 330.

Various algorithms such as Motion Compensated Temporal Filtering (MCTF) are used to remove temporal redundancies in scalable video coding. While a Haar filter was used in a conventional MCTF, a 5/3 filter has been recently widely used. MCTF is performed on a group of picture (GOP) basis and includes generating a predicted frame using the result of motion estimation, obtaining a residual frame (high-pass subband) that is the difference between a current frame and the predicted frame, and updating the remaining original frame or a low-pass subband using the residual frame. As the result of performing this process iteratively, temporal redundancies are removed in frames making up a GOP to obtain one low-pass subband and a plurality of high-pass subbands.

The spatial transformer 330 removes spatial redundancies in the frames in which temporal redundancies have been removed using spatial transform and creates transform coefficients. The spatial transform is performed using DCT or wavelet transform. The video encoder 300 may use wavelet transform to generate a bitstream having spatial scalability. Alternatively, the video encoder 300 with a plurality of layers of different resolutions may use DCT to remove spatial redundancies in the frames in which the temporal redundancies have been removed in order to generate a bitstream having spatial scalability.

The quantizer 340 quantizes the transform coefficients in such a way as to minimize distortion at a given bit rate. Quantization for scalable video coding is performed using well-known embedded quantization algorithms such as Embedded ZeroTrees Wavelet (EZW), Set Partitioning in Hierarchical Trees (SPIHT), Embedded ZeroBlock Coding (EZBC), and Embedded Block Coding with Optimized Truncation (EBCOT). The quantized transform coefficients (texture information) are inserted into a bitstream after being subjected to scanning, scaling, and variable length coding. Meanwhile, the bitstream contains texture information as well as motion information. To insert the motion information into the bitstream, the video encoder 300 includes the motion vector selector 360 and the motion information encoder 370.

The motion vector selector 360 selects either one of a base layer motion vector and an enhancement layer motion vector for each block. More specifically, an enhancement layer motion vector is selected in the order from a block with a largest difference to a block with a smallest difference between visual qualities obtained when temporal redundancies are removed using base layer motion compensation and enhancement layer motion compensation, respectively. For example, when the extent to which visual quality is improved decreases in the order of blocks 1, 2, 3, 4, 5, 6, 7, and 8 and enhancement layer motion compensation can be used only for three blocks, the motion vector selector 360 selects enhancement layer motion vectors for blocks 1 through 3 and base layer motion vectors for blocks 4 through 8. The selected motion information (base layer motion vectors and enhancement layer motion vectors) is provided to the motion information encoder 370. Consequently, the texture information contained in the bitstream is the quantized transform coefficients obtained from enhancement layer motion compensation, spatial transform, and quantization while the motion information contained therein is the enhancement layer motion vectors for blocks 1 through 3 and the base layer motion vectors for blocks 4 through 8.

The motion vector selector 360 receives information about the order of blocks in which the extent to which video quality is improved decreases (hereinafter called ‘order information’) from the motion compensator 320. The percentage of enhancement layer motion vectors selected by the motion vector selector 360 may be input manually by a user or be determined automatically according to a bit rate. When motion information is merged according to a bit rate, the motion vector selector 360 selects a high percentage of enhancement layer motion vectors for a high bit rate while selecting a low percentage of enhancement layer motion vectors for a low bit rate.

The motion information encoder 370 encodes the motion information using arithmetic coding or variable length coding. The encoded motion information is inserted into the bitstream. When motion vectors contained in the motion information have consistency, coding efficiency for the motion information is high. In the present exemplary embodiment, to obtain motion vectors having consistency, the motion estimator 310 estimates motion vectors (base layer motion vectors and enhancement layer motion vectors) using an HVSBM algorithm.

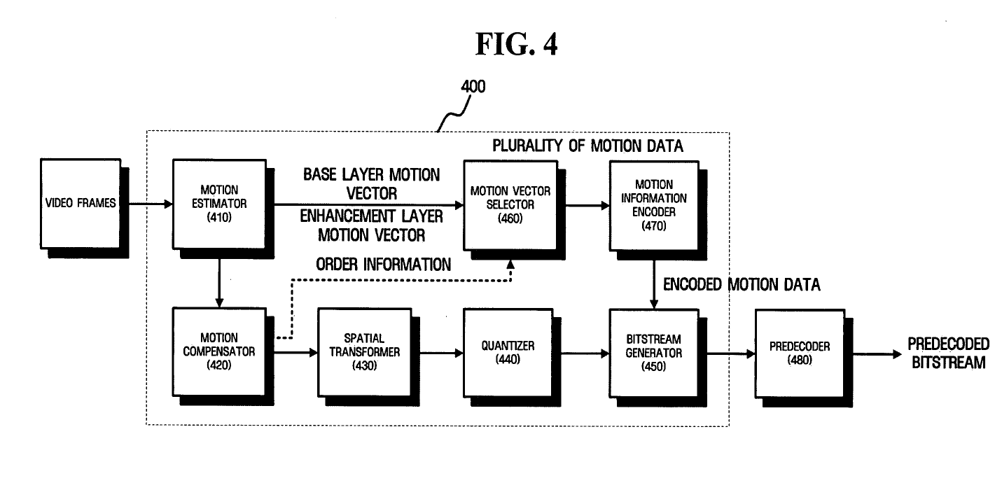

The bitstream generator 350 generates a bitstream containing the texture information and the encoded motion information. While it is described above that the motion vector for each block contained in the encoded motion information is either a base layer motion vector or an enhancement layer motion vector, the motion vector may contain the base layer motion vector and residual motion vector needed for obtaining the enhancement layer motion vector, instead of the enhancement layer motion vector. The same can apply to a video encoder shown in FIG. 4.

FIG. 4 is a block diagram of a video encoder 400 according to a second exemplary embodiment of the present invention.

Referring to FIG. 4, a motion estimator 410, a motion compensator 420, a spatial transformer 430, and a quantizer 440 in the video encoder 400 have substantially the same functions as their counterparts in the video encoder 300 of FIG. 3.

However, a motion vector selector 460, a motion information encoder 470, and a bitstream generator 450 operate in a slightly different way than their counterparts in the video encoder 300.

The motion vector selector 460 generates a plurality of types of motion data, each having a different percentage of base layer motion vectors and enhancement layer motion vectors. For example, the motion vector selector 460 may generate a total of types of six motion data. A first type of motion data consists of enhancement layer motion vectors for all blocks. A second type of motion data consists of enhancement layer motion vectors for 80 percent of the blocks and base layer motion vectors for 20 percent of the blocks. A third type of motion data consists of enhancement layer motion vectors for 60 percent of the blocks and base layer motion vectors for 40 percent of the blocks. A fourth type of motion data contains enhancement layer motion vectors for 40 percent of the blocks and base layer motion vectors for 60 percent of the blocks. A fifth type of motion data contains enhancement layer motion vectors for 20 percent of the blocks and base layer motion vectors for 80 percent of the blocks. A sixth type of motion data contains base layer motion vectors for all blocks. The six types of motion data are all inserted into the bitstream. Meanwhile, a video decoder receives a bitstream predecoded by a predecoder 480 in order to reconstruct video frames using one type of motion data.

As the number of types of motion data created by the motion vector selector 460 increases, the motion scalability of a bitstream increases while the size of the bitstream increases. On the other hand, as the number of types of motion data decreases, the motion scalability of a bitstream decreases while the size of the bitstream decreases. Each type of motion data may contain a different percentage of enhancement layer motion vectors than in the above example. For example, when the motion vector selector 460 generates six types of motion data, the percentages of enhancement layer motion vectors contained in the six types of motion vector data may be 100, 70, 40, 20, 10, and 0, respectively.

The motion information encoder 470 encodes the plurality of types of motion data using arithmetic coding or variable length coding in order to reduce the amount of data.

The bitstream generator 450 generates a bitstream containing the texture information and the encoded motion data.

The predecoder 480 truncates encoded motion data excluding one type of motion data for transmission to the decoder. For example, when a bandwidth for transmitting a bitstream to the decoder is very narrow, the predecoder 480 truncates encoded motion vector data excluding motion data containing the lowest percentage (e.g., 0%) of enhancement layer motion vectors. Conversely, when a bandwidth for transmitting a bitstream to the decoder is very wide, the predecoder 480 truncates encoded motion vector data excluding motion data containing the highest percentage (e.g., 100%) of enhancement layer motion vectors. In a similar fashion, the predecoder 480 truncates encoded motion data excluding one type of motion data suitably selected according to a bit rate.

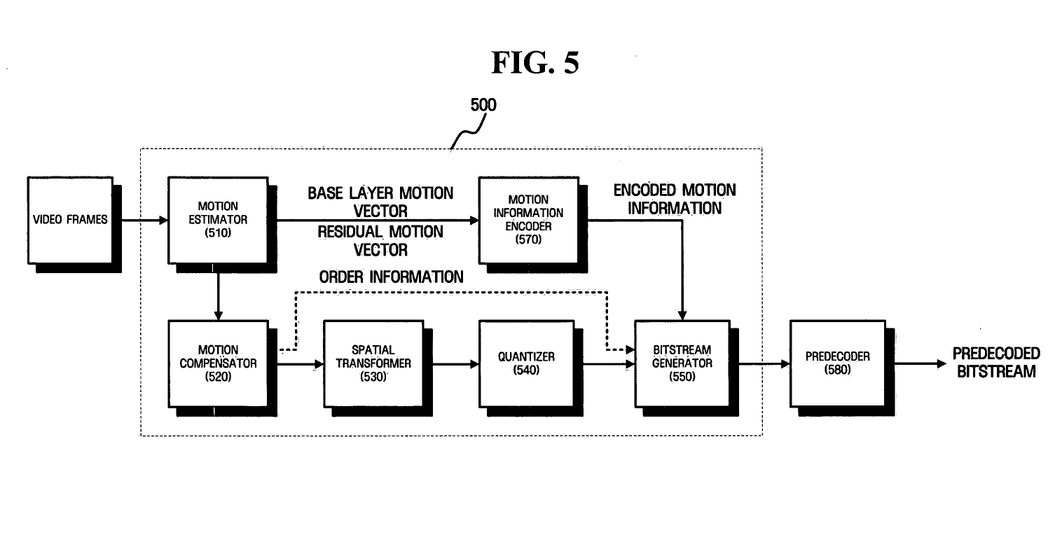

FIG. 5 is a block diagram of a video encoder 500 according to a third exemplary embodiment of the present invention.

Referring to FIG. 5, a motion estimator 510, a motion compensator 520, a spatial transformer 530, a quantizer 540, a bitstream generator 550, and a motion information encoder 570 in the video encoder 500 have substantially the same functions as their counterparts in the video encoder 300 of FIG. 3.

Unlike the video encoder 300 of FIG. 3, the video encoder 500 does not include a motion vector selector. Thus, the motion information encoder 570 encodes information containing both a base layer motion vector and an enhancement layer motion vector for each block. The encoded motion information (base layer motion vectors and enhancement layer motion vectors) is inserted into a bitstream.

The bitstream generator 550 generates a bitstream containing the texture information, the encoded motion information, and the order information.

The predecoder 580 truncates encoded motion information from an enhancement layer motion vector for a block showing the smallest quality improvement. For example, the predecoder 580 truncates all the encoded enhancement layer motion vectors when a bit rate is very low while retaining the enhancement layer motion vectors when a bit rate is sufficient.

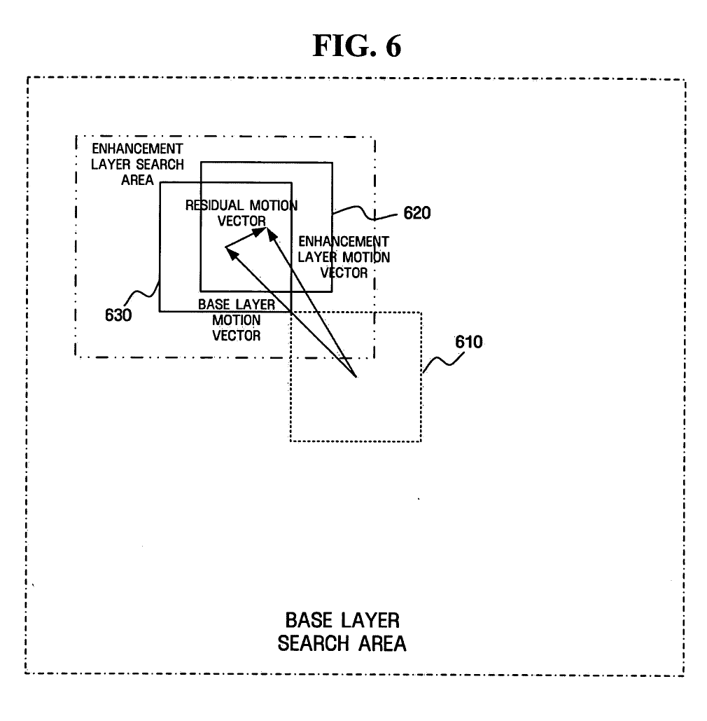

FIG. 6 illustrates a motion estimation process according to an exemplary embodiment of the present invention.

A base layer motion vector, an enhancement layer motion vector, and a residual motion vector are shown in FIG. 6. First, the base layer motion vector and the enhancement layer motion vector are obtained from a base layer motion search and an enhancement layer motion search, respectively, and a residual motion vector is the difference between the enhancement layer motion vector and the base layer motion vector.

A block 610 is a block in a current frame, a block 620 is a block corresponding to the block 610, and a block 630 is a block obtained from a base layer motion search. In a conventional motion estimation process, the block 620 corresponding to the block 610 is directly found. By contrast, in the exemplary embodiment of the present invention, the block 620 is found using an enhancement layer motion search after the block 630 is found using a base layer motion search. A block-matching scheme used in the exemplary embodiment of the present invention will now be described.

A block at a position that minimizes the cost for encoding a block in a current frame is determined as a block corresponding to the block in the current frame. Where E(k, 1) and B(k, 1) respectively denote bits allocated to texture and motion vectors when encoding a k-th block in a current frame using an 1-th block in a search area of a reference frame, the cost C(k, 1) is defined by Equation (1):
C(k, l)=E(k, l)+λB(k, l) (1)

Here, λ is a Lagrangian coefficient used to control the balance among the bits allocated to motion vectors and textures. As λ increases, the number of bits allocated to texture increases. As λ decreases, the number of bits allocated to motion vectors increases. When bits are insufficient to be allocated to motion vectors at a very low bit rate, λ is made so large that bits are mainly allocated to texture.

To obtain a base layer motion vector, a value 1 that minimizes the cost C(k, 1) is found and a displacement between the block 630 in the reference frame corresponding to the value 1 and the block 610 in the current frame is calculated. After the base layer motion vector is determined in this way, the block 620 is found within an enhancement layer search area using Equation (1). The enhancement layer search area may be significantly narrower than the base layer search area in order to minimize the difference between the base layer motion vector and the enhancement layer motion vector. Similarly, the block 620 that minimizes the cost is found and the difference between the block 620 and the block 630 found using the base layer motion search is determined as the enhancement layer motion vector. The base layer motion search uses λ greater than the enhancement layer motion search so that a small number of bits can be allocated to the base layer motion vector. Thus, for a very low bit rate, texture and base layer motion information are contained in the bitstream in order to minimize the number of bits being allocated to the motion vector.

The base layer motion search and the enhancement layer motion search may be performed using HVSBM. HVSBM providing consistent motion vector fields reduces the overall bit rate of the motion vectors. Furthermore, HVSBM requires a small amount of calculations and also achieves motion scalability by restricting an enhancement layer search area to a small region. The result of an actual experiment demonstrated that a peak signal-to-noise ration (PSNR) is nearly constant regardless of the size of the enhancement layer search area.

The bitstream generated by the video encoder 300 of FIG. 3 contains a single type of motion data consisting of either a base layer motion vector or an enhancement layer for each block. The bitstream generated by the video encoder 400 of FIG. 4 contains a plurality of types of motion data, each consisting of either a base layer motion vector or an enhancement layer motion vector for each block. The motion data also has a different percentage of enhancement layer motion vectors. Thus, the bitstream is predecoded and truncated excluding particular motion data for transmission to a video decoder. The bitstream generated by the video encoder 500 of FIG. 5 contains a single type motion data consisting of both a base layer motion vector and a residual motion vector for each block. Thus, the bitstream is predecoded according to a bit rate to transmit only base layer motion vectors for some blocks and both base layer motion vectors and residual motion vectors for the remaining blocks to the video decoder.

The video encoder 300 of FIG. 3 may include a motion vector merger merging a base layer motion vector with a residual motion vector instead of the motion vector selector 360. In this case, base layer motion vectors and residual motion vectors are provided to the motion vector merger while the motion information containing base layer motion vectors and enhancement layer motion vectors is provided to the motion information encoder 370. Each of the enhancement layer motion vectors is obtained by merging a base layer motion vector with a residual motion vector. The video encoder 400 of FIG. 4 may also include a motion vector merger instead of the motion vector selector 460.

Meanwhile, while it is described above that the bitstream generated by the video encoder 500 of FIG. 5 contains both a base layer motion vector and a residual motion vector for each block, an enhancement layer motion vector may be inserted into the bitstream instead of the residual motion vector. In this case, the predecoder 580 selectively truncates a base layer motion vector or an enhancement layer motion vector for each block according to a bit rate and order information.

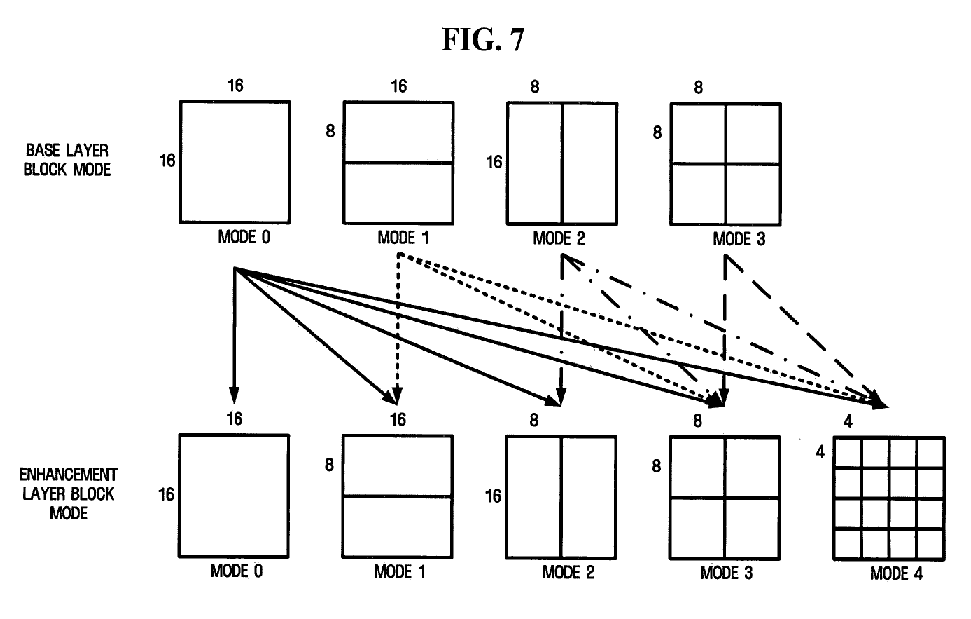

FIG. 7 illustrates block modes according to an exemplary embodiment of the present invention. Referring to FIG. 7, the motion scalability achieved using a small enhancement layer search area as described above is intensified when the concept of a block mode is introduced.

In mode 0, a motion vector search is performed in units of a 16*16 block. In mode 1, mode 2, mode 3, and mode 4, a motion vector search is made in 8*16, 16*8, 8*8, and 4*4 subblocks, respectively.

In the present exemplary embodiment, a base layer block mode is one of mode 0, mode 1, mode 2, and mode 3 while an enhancement layer block mode is one of mode 0, mode 1, mode 2, mode 3, and mode 4. When the base layer block mode is mode 0, the enhancement layer block mode is selected from mode 0, mode 1, mode 2, mode 3, and mode 4. When the base layer block mode is mode 1, the enhancement layer block mode is selected from mode 1, mode 3, and mode 4. When the base layer block mode is mode 2 and mode 3, respectively, the enhancement layer block mode is selected from modes 2 through 4 and modes 3 and 4, respectively. When the base layer block mode is mode 1, the enhancement layer block mode cannot be mode 2 since mode 1 and mode 2 are horizontal mode and vertical mode, respectively.

Since the base layer motion search uses λ greater than the enhancement layer motion search as described above, a larger penalty is inflicted on a base layer even if the number of bits allocated to motion vector estimated during the base layer motion search (base layer motion vector) is equal to the number of bits allocated to motion vector estimated during the enhancement layer motion search (base layer motion vector and enhancement layer motion vector). Thus, in an actual experiment, mode 0 was determined as a base layer block mode except for special cases. On the other hand, since the enhancement layer uses small X, penalty for the number of bits being allocated to a motion vector is less than for the base layer. For this reason, an enhancement layer block mode usually has more finely subdivided blocks. While FIG. 7 shows five block modes, the number of block modes available may be greater than or less than five.

According to the exemplary embodiments of the present invention, a texture image contained in the bitstream is obtained by performing spatial transform and quantization on frames in which temporal redundancies have been removed using enhancement layer motion vectors. Thus, when motion vectors for some blocks are base layer motion vectors at a low bit rate, motion mismatch may occur. The motion mismatch is introduced since an enhancement layer motion vector is used during encoding but a base layer motion vector is used during decoding, which results in degradation of coding performance (e.g., visual quality, compression efficiency, etc).

Thus, to minimize the motion mismatch, the present invention proposes an algorithm for determining an enhancement layer motion vector or a base layer motion vector for each block. The degree E of a mismatch resulting from the use of a base layer motion vector at a decoder is given by Equation (2) as follows:
E=Σ|Oₘ−O_{b}| (2)
where Oₘ and O_{b} are frames reconstructed using enhancement layer motion vectors and base layer motion vectors, respectively. Oₘ and O_{b} are defined by Equation (3) as follows:
Oₘ=Pₘ+Hₘ
O_{b}=P_{b}+Hₘ (3)
where Pₘ and Hₘ are a predicted frame and a resiual frame obtained using enhancement layer motion vectors, respectively, and P_{b} is a frame predicted using base layer motion vectors.

Assuming that there is no quantization loss in video coding, Oₘ may be defined by Equation (4) as follows:
Oₘ=P_{b}+H_{b} (4)
where H_{b} is a residual frame obtained using base layer motion vectors.

Substituting Equations (3) through (4) into Equation (2) and rearranging gives Equation (5) as follows:
E=Σ|Oₘ−O_{b}|=Σ|Pₘ−P_{b}|=Σ|Hₘ−H_{b}| (5)

As defined by Equation (5), the degree E of mismatch is determined by the difference between frames predicted using enhancement layer motion vectors and base layer motion vectors or the difference between residual frames obtained using enhancement layer motion vectors and base layer motion vectors.

Referring to FIGS. 3 through 5, predicted frames and residual frames are obtained by the motion compensator 320, 420, or 520. That is, the motion compensator 320, 420, or 520 receives base layer motion vectors and enhancement layer motion vectors from the motion estimator 310, 410, or 510 to generate predicted frames Pₘ and Pb and residual frames Hm and Hb.

In the present invention, the significance of each block may be determined using Equation (5). That is, the difference between encoding of each block using enhancement layer motion compensation and using base layer motion compensation is calculated and the order of significance of blocks is determined according to the degree of difference. For example, the order of significance may be determined by the difference between residual blocks (the difference between a block in a current frame and a block in a predicted frame) obtained using enhancement layer motion compensation and base layer motion compensation. That is, when there is a large difference between residual blocks, the difference between encoding of each block using enhancement layer motion compensation and using base layer motion compensation is also considered large. The order of significance of blocks may be calculated by a motion vector selector instead of a motion estimator.

The motion vector selector 360 or 460 in FIG. 3 or 4 selects an enhancement layer motion vector in the order of significance. That is, an enhancement layer motion vector is preferentially allocated to a block with a large error. Meanwhile, a bitstream generated by the video encoder of FIG. 5 not including a motion vector selector contains base layer motion vectors and residual motion vectors for all blocks and order information. Using the order information, the predecoder 580 truncates motion information from residual motion vectors with least significance as needed according to a bit rate.

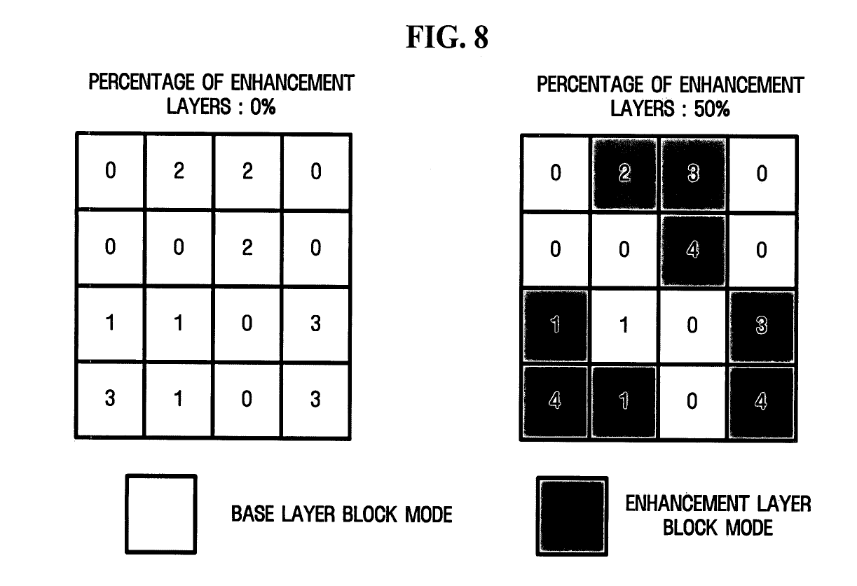

FIG. 8 illustrates examples of a frame in which the percentage of enhancement layers is 0% and 50%, respectively.

Referring to FIG. 8, when the percentage of enhancement layer is 0%, all texture information is generated using enhancement layer motion compensation while all blocks are subjected to inverse base layer motion compensation during video coding. When the percentage of enhancement layers is 50%, all texture information is generated using enhancement layer motion compensation while 50% of the blocks are subjected to inverse enhancement layer motion compensation and the remaining 50% of the blocks are subjected to inverse base layer motion compensation.

A block mode number is indicated within a block. As illustrated in FIG. 8, a base layer block mode and an enhancement layer block mode may vary for the same block. When the base layer block mode is different from the enhancement layer block mode, an enhancement layer block mode is used for a block being subjected to inverse enhancement layer motion compensation during decoding while a base layer block mode is used for a block being subjected to inverse base layer motion compensation.

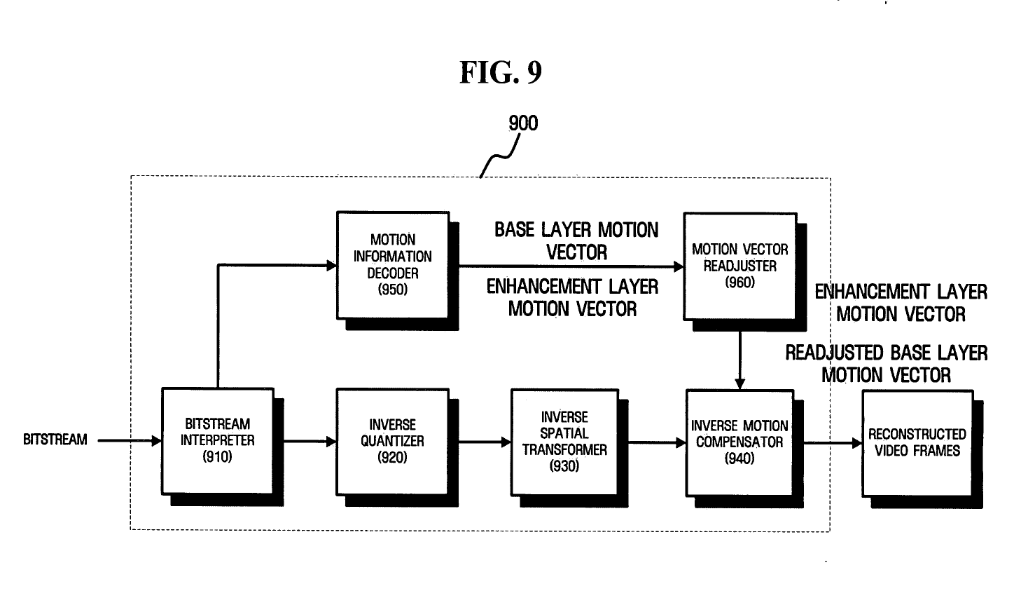

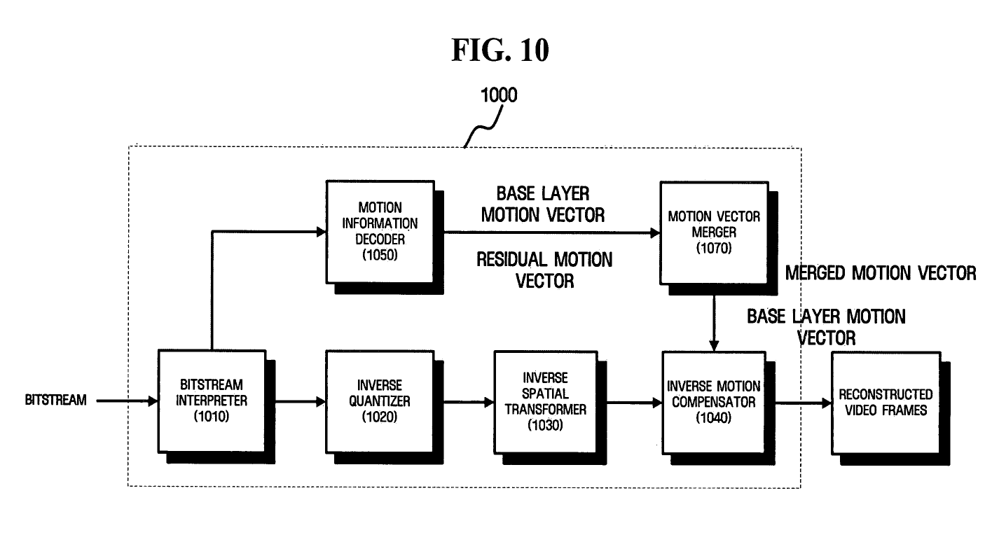

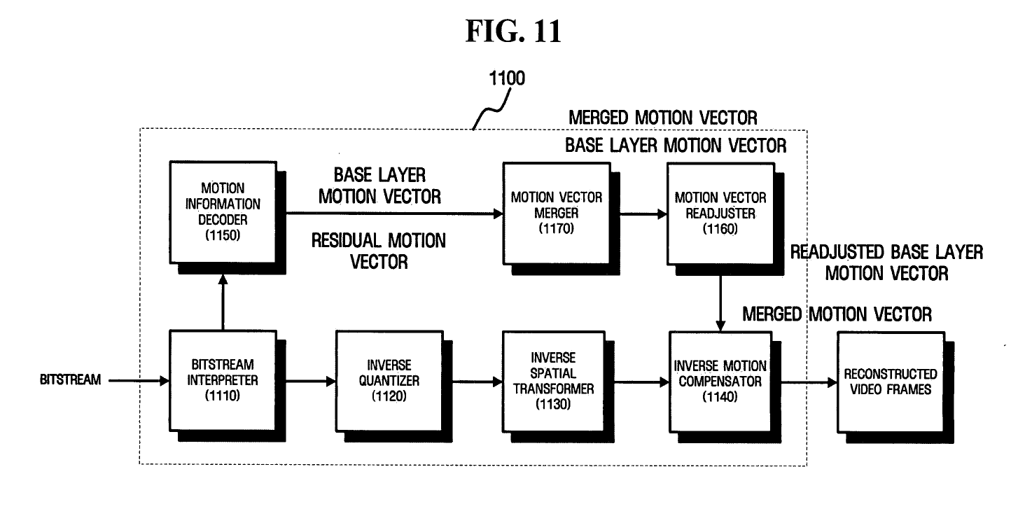

Video decoders reconstructing video frames encoded using MCTF-based scalable video coding will now be described with reference to FIGS. 9 through 11. FIG. 9 shows a video decoder 900 for decoding the bitstream generated by the video encoder 300 of FIG. 3 or the predecoded bitstream generated by the predecoder 480 shown in FIG. 4. FIGS. 10 and 11 show video decoders for decoding a predecoded bitstream generated by the predecoder 580 shown in FIG. 5.

FIG. 9 is a block diagram of a video decoder 900 according to a first exemplary embodiment of the present invention.

Referring to FIG. 9, the video decoder 900 includes a bitstream interpreter 910, an inverse quantizer 920, an inverse spatial transformer 930, an inverse motion compensator 940, a motion information decoder 950, and a motion vector readjuster 960.

The bitstream interpreter 910 obtains texture information and encoded motion information from an input bitstream. The texture information containing image data of encoded video frames is provided to the inverse quantizer 920 while the encoded motion information containing either a base layer motion vector or an enhancement layer motion vector for each block is provided to the motion information decoder 950.

The inverse quantizer 920 inversely quantizes the texture information to obtain transform coefficients. The obtained transform coefficients are sent to the inverse spatial transformer 930.

The inverse spatial transformer 930 performs inverse spatial transform on the transform coefficients to obtain a single low-pass subband and a plurality of high-pass subbands for each GOP.

The inverse motion compensator 940 receives the low-pass subband and the plurality of high-pass subbands for each GOP to update the low-pass subband using one or more high-pass subbands and generate a predicted frame using the updated low-pass subband. The inverse motion compensator 940 then adds the predicted frame to a high-pass subband, thereby reconstructing a low-pass subband. The inverse motion compensator 940 updates the updated low-pass subband and the reconstructed low-pass subbands again, generates two predicted frames using the updated low-pass subbands, and reconstructs two low-pass subbands by adding the two predicted frames to two high-pass subbands, respectively. The inverse motion compensator 940 performs the above process iteratively to reconstruct video frames making up a GOP. The motion vectors used during an update operation and a predicted frame generation operation is obtained from motion information (a base layer motion vector or an enhancement layer motion vector for each block) obtained by the motion information decoder 950 decoding the encoded motion information. The resulting motion information contains base layer motion vectors and enhancement layer motion vectors. The base layer motion vectors are provided to the motion vector readjuster 960 that then readjust a base layer motion vector using enhancement layer motion vectors for neighboring blocks. Alternatively, the motion vector readjuster 960 may readjust the base layer motion vectors using a predicted frame produced during inverse motion compensation as a reference. The enhancement layer motion vectors and the readjusted base layer motion vectors are provided to the inverse motion compensator 940 for use in an update operation and a predicted frame generation operation.

FIG. 10 is a block diagram of a video decoder 1000 according to second exemplary embodiment of the present invention.

Referring to FIG. 10, the video decoder 1000 includes a bitstream interpreter 1010, an inverse quantizer 1020, an inverse spatial transformer 1030, an inverse motion compensator 1040, a motion information decoder 1050, and a motion vector merger 1070.

The bitstream interpreter 1010 obtains texture information and encoded motion information from an input bitstream. The texture information containing image data of encoded video frames is provided to the inverse quantizer 1020 while the encoded motion information containing motion vectors is provided to the motion information decoder 1050.

The inverse quantizer 1020 inversely quantizes the texture information to obtain transform coefficients that are then sent to the inverse spatial transformer 1030. The inverse spatial transformer 1030 performs inverse spatial transform on the transform coefficients to obtain a single low-pass subband and a plurality of high-pass subbands for each GOP. The inverse motion compensator 1040 receives the low-pass subband and the plurality of high-pass subbands for each GOP to reconstruct video frames.

The motion information decoder 1050 decodes encoded motion information to obtain motion information. The motion information contains base layer motion vectors for some blocks and base layer motion vectors and residual motion vectors for the remaining blocks. The base layer motion vectors and residual motion vectors for the remaining blocks are sent to the motion vector merger 1070.

The motion vector merger 1070 merges the base layer motion vector with the residual motion vector to obtain an enhancement layer motion vector that is then provided to the inverse motion compensator 1040 for use in an update operation and a predicted frame generation operation.

FIG. 11 is a block diagram of a video decoder according to a third exemplary embodiment of the present invention.

The video decoder 1100 includes a bitstream interpreter 1110, an inverse quantizer 1120, an inverse spatial transformer 1130, an inverse motion compensator 1140, a motion information decoder 1150, a motion vector merger 1170, and a motion vector readjuster 1160. The components of the video decoder 1100 have substantially the same functions as their counterparts in the video decoder 1000 of FIG. 10. Unlike the video decoder 1000 of FIG. 10, the video decoder 1100 further includes the motion vector readjuster 1160.

The motion vector readjuster 1160 readjusts the base layer motion vector using merged motion vectors for neighboring blocks. Alternatively, the motion vector readjuster 1160 may readjust the base layer motion vectors using a predicted frame obtained during inverse motion compensation as a reference. The merged motion vectors and the readjusted motion vectors are provided to the inverse motion compensator 1140 for use in an update operation and a predicted frame generation operation.

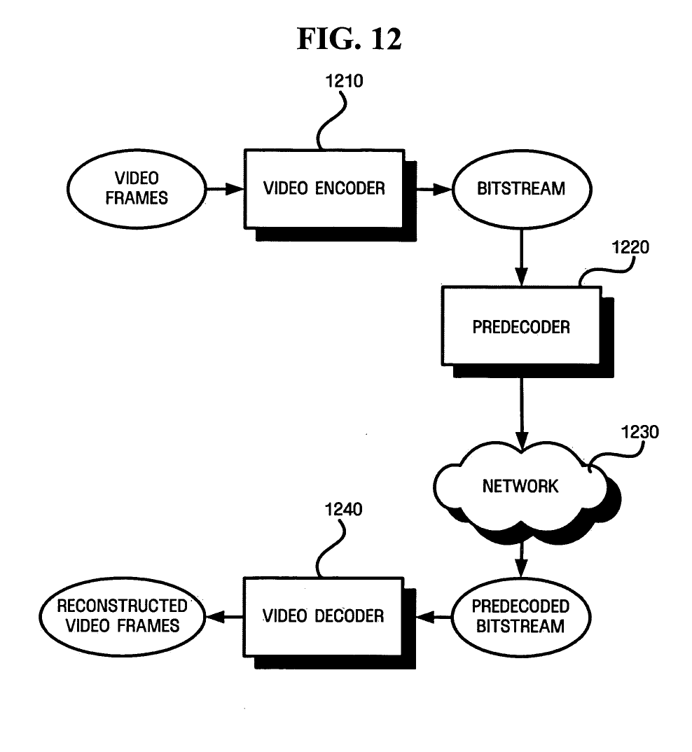

FIG. 12 illustrates a video service environment according to an exemplary embodiment of the present invention.

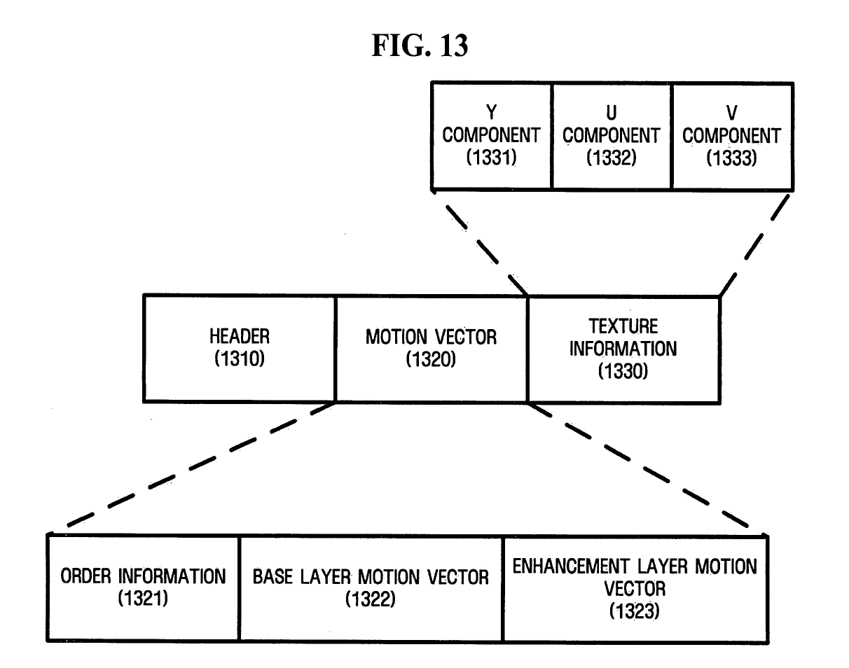

Referring to FIG. 12, a video encoder 1210 encodes video frames into a bitstream using scalable video coding. The structure of a bitstream generated according to the exemplary embodiments of the present invention will be described later with reference to FIG. 13.

A predecoder 1220 truncates a part of the bitstream (predecoding) according to a bandwidth on a network 1230. For example, when the bandwidth of the network 1230 is sufficient, a user requests high quality video. The predecoder 1220 truncates a small number of bits in the bitstream or no bits. On the other hand, when the available bandwidth is not sufficient, the predecoder 1220 truncates a large number of bits in the bitstream.

A video decoder 1240 receives the predecoded bitstream through the network 1230 to reconstruct video frames.

FIG. 13 illustrates the structure of a bitstream according to an exemplary embodiment of the present invention.

Referring to FIG. 13, the bitstream is composed of a header 1310, a motion vector field 1320, and a texture information field 1330.

The header 1310 may contain a sequence header, a GOP header, a frame header, and a slice header specifying information necessary for a sequence, a GOP, a frame, and a slice, respectively.

The motion vector field 1320 includes an order information field 1321, a base layer motion vector field 1322, and an enhancement layer motion vector field 1323.

The order information field 1321 contains information about the order of blocks in which the degree of video quality improvement decreases. For example, when enhancement layer motion vectors are used for blocks 1 through 6 and the degree of visual quality improvement decreases in the order of blocks 1, 4, 2, 3, 5, and 6, the order information specifies the order as 1, 4, 2, 3, 5, 6. Thus, the enhancement layer motion vectors are truncated during predecoding in the order of blocks (6, 5, 3, 2, 4, 1) in which the degree of visual quality improvement increases.

The base layer motion vector field 1322 contains information about motion vectors obtained when a small number of bits are allocated to a motion vector.

The enhancement layer motion vector field 1323 contains information about motion vectors obtained when a large number of bits are allocated to a motion vector.

A predecoder selectively truncates a base layer motion vector or an enhancement layer motion vector for a particular block. That is, on the one hand, when the enhancement layer motion vector is determined for the block, the predecoder truncates the base layer motion vector in a bitstream. On the other hand, when the base layer motion vector is determined for the block, the predecoder truncates the enhancement layer motion vector in the bitstream.

Alternatively, the motion vector field 1320 may include the base layer motion vector field 1322 and a residual motion vector field. In this case, when a base layer motion vector is determined for a particular block, the predecoder truncates a residual motion vector in the bitstream. On the other hand, when an enhancement layer motion vector is determined for the block, the predecoder does not truncate the base layer motion vector. That is, a video decoder uses the base layer motion vector and the residual motion vector for the block to reconstruct an enhancement layer motion vector for inverse motion compensation.

The texture information field 1330 contains a Y Component field 1331 specifying texture information of Y component, a U Component field 1332 specifying texture information of U component, and a V Component field 1333 specifying texture information of V component.

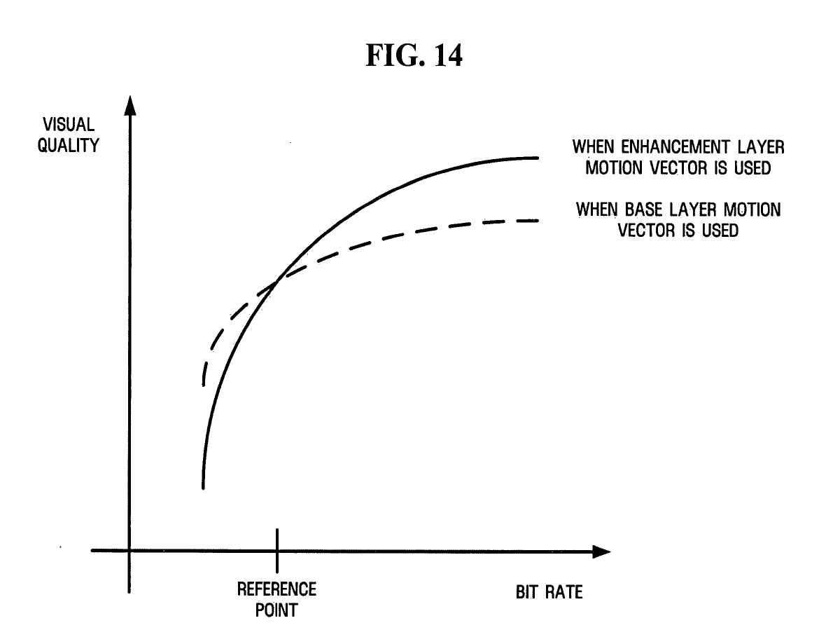

A process of reducing the bit rate of a bitstream encoded using scalable video coding will now be described with reference to FIG. 14.

FIG. 14 is a graph illustrating changes in video qualities when an enhancement layer motion vector and a base layer motion vector are used.

As illustrated in FIG. 14, for a high bit rate, the quality of video reconstructed by a decoder when an enhancement layer motion vector is used is higher than that when a base layer motion vector is used. However, when a bit rate is extremely low, the quality of reconstructed video when the base layer motion vector is used is higher than that when the enhancement layer motion vector is used.

Thus, upon receiving a request for a bitstream having a bit rate higher than a reference point, the predecoder provides all enhancement layer motion vectors while truncating unnecessary bits of a texture. On the other hand, upon receiving a request for a bitstream having a bit rate lower than the reference point, the predecoder truncates bits of the texture as well as a part or all of the enhancement layer motion vectors.

The reference point can be experimentally obtained from various video sequences.

Meanwhile, when a bit rate is extremely low, the predecoder may truncate all motion vectors (base layer motion vectors and enhancement layer motion vectors).

As described above, video coding providing motion scalability can be achieved by the video coding and decoding methods and video encoder and decoder according to the present invention. Unlike a conventional video coding that suffers degradation of visual quality since the number of bits contained in motion information is difficult to adjust at a very low bit rate, the video coding and decoding methods according to the present invention provide improved visual quality by minimizing the number of bits contained in motion information at a very low bit rate.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A video coding method comprising:
estimating a base layer motion vector and an enhancement layer motion vector for each block in a video frame;
removing temporal redundancies in the video frame using the enhancement layer motion vectors;
spatially transforming the video frame in which the temporal redundancies have been removed and quantizing the video frame which has been spatially transformed to obtain texture information;
selecting one of the base layer motion vector and the enhancement layer motion vector for each block; and
generating a bitstream containing the base layer motion vector or the enhancement layer motion vector which is selected for each block and the texture information.

2. The method of claim 1, wherein the base layer motion vector is estimated using hierarchical variable size block matching.

3. The method of claim 1, wherein the enhancement layer motion vector is estimated by readjusting the base layer motion vector.

4. The method of claim 1, wherein the base layer motion vector and the enhancement layer motion vector each have one of a plurality of block modes.

5. The method of claim 1, wherein the selecting of the one of the base layer motion vector and the enhancement layer motion vector comprises:
calculating a difference between residual blocks obtained using a base layer motion vector and an enhancement layer motion vector;
determining a significance order of blocks according to the difference; and
selecting enhancement layer motion vectors for a predetermined percentage of the blocks in the order from a block with a largest significance to a block with a smallest significance and base layer motion vectors for a remaining percentage of the blocks.

6. A video coding method comprising:
estimating a base layer motion vector and an enhancement layer motion vector for each block in a video frame;
removing temporal redundancies in the video frame using the enhancement layer motion vectors;
spatially transforming the video frame in which the temporal redundancies have been removed and quantizing the video frame which has been spatially transformed to obtain texture information; and
generating a bitstream containing the base layer motion vector, a residual motion vector which is a difference between the base layer motion vector and the enhancement layer motion vector, and the texture information, for each block.

7. The method of claim 6, wherein the base layer motion vector is estimated using hierarchical variable size block matching.

8. The method of claim 6, wherein the enhancement layer motion vector is estimated by readjusting the base layer motion vector.

9. The method of claim 6, wherein the base layer motion vector and the enhancement layer motion vector respectively each have one of a plurality of block modes.

10. The method of claim 6, further comprising calculating a difference between encoding of each block using the enhancement layer motion vector and the base layer motion vector, and determining an order of significance of blocks according to the degree of difference,
wherein the order of significance of blocks is contained in the bitstream.

11. The method of claim 10, wherein the difference is obtained by calculating a difference between a residual block obtained using the enhancement layer motion vector for the block and a residual block obtained using the base layer motion vector for the block.

12. A video encoder comprising:
a motion estimator which estimates a base layer motion vector and an enhancement layer motion vector for each block in a video frame;
a motion compensator which removes temporal redundancies in the video frame using the enhancement layer motion vectors;
a spatial transformer which spatially transforms the video frame in which the temporal redundancies have been removed;
a quantizer which quantizes the video frame which has been spatially transformed to obtain texture information;
a motion vector selector which selects one of the base layer motion vector and the enhancement layer motion vector for each block; and
a bitstream generator generating a bitstream containing the base layer motion vector or the enhancement layer motion vector selected for each block and the texture information.

13. The video encoder of claim 12, wherein the motion estimator estimates the base layer motion vector using hierarchical variable size block matching.

14. The video encoder of claim 12, wherein the motion estimator estimates the enhancement layer motion vector by readjusting the base layer motion vector.

15. The video encoder of claim 12, wherein the motion estimator estimates the base layer motion vector and the enhancement layer motion vector for the respective blocks in at least one of a plurality of block modes.

16. The video encoder of claim 12, wherein the motion estimator calculates a difference between residual blocks obtained using a base layer motion vector and an enhancement layer motion vector, and determines the significance order of blocks according to the difference, and the motion vector selector selects enhancement layer motion vectors.

17. A video encoder comprising:
a motion estimator which estimates a base layer motion vector and an enhancement layer motion vector for each block in a video frame;
a motion compensator which removes temporal redundancies in the video frame using the enhancement layer motion vectors;
a spatial transformer spatially which transforms the video frame in which the temporal redundancies have been removed;
a quantizer quantizing the video frame which has been spatially transformed to obtain texture information; and
a bitstream generator which generates a bitstream containing the base layer motion vector, a residual motion vector which is a difference between the base layer motion vector and the enhancement layer motion vector, and the texture information for each block.

18. The video encoder of claim 17, wherein the motion estimator estimates the base layer motion vector using hierarchical variable size block matching.

19. The video encoder of claim 17, wherein the motion estimator estimates the enhancement layer motion vector by readjusting the base layer motion vector.

20. The video encoder of claim 17, wherein the motion estimator estimates the base layer motion vector and the enhancement layer motion vector for the respective blocks in at least one of a plurality of block modes.

21. The video encoder of claim 17, wherein the motion estimator calculates a difference between residual blocks obtained using a base layer motion vector and an enhancement layer motion vector, determines the significance order of blocks according to the difference, and carries the significance order of blocks to the bitstream generator so that the bitstream generator inserts the significance order of blocks into the bitstream.

22. A predecoding method comprising:
receiving a bitstream containing a base layer motion vector, a residual motion vector which is a difference between the base layer motion vector and an enhancement layer motion vector for each block of a video frame, and texture information obtained by encoding the video frame, associated with each block in the video frame; and
truncating at least a part of the residual motion vectors.

23. The method of claim 22, wherein the bitstream further includes a significance order of the blocks, and
wherein in the truncating of the at least the part of the residual motion vectors, the residual motion vectors are truncated from a residual motion vector with least significance using the significance order of the blocks as a reference.

24. The method of claim 22, wherein if a rate of a requested bitstream is lower than a predetermined reference point, the at least the part of the residual motion vectors is truncated.

25. A video decoding method comprising:
interpreting an input bitstream and obtaining texture information and motion information containing base layer motion vectors and enhancement layer motion vectors;
readjusting the base layer motion vectors;
performing inverse quantization and inverse spatial transform on the texture information to obtain frames in which temporal redundancies are removed; and
performing inverse motion compensation on the frames in which the temporal redundancies have been removed using the base layer motion vectors which have been readjusted and the enhancement layer motion vectors.

26. The method of claim 25, wherein the base layer motion vectors are readjusted using enhancement layer motion vectors for neighboring blocks as a reference.

27. The method of claim 25, wherein the base layer motion vectors are readjusted using a predicted frame generated during the inverse motion compensation.

28. A video decoding method comprising:
interpreting an input bitstream and obtaining texture information and motion information containing base layer motion vectors and residual motion vectors;
merging a base layer motion vector with a residual motion vector for each of a plurality of blocks having both the base layer motion vector and the residual motion vector and obtaining merged motion vectors;
performing inverse quantization and inverse spatial transform on the texture information and obtaining frames in which temporal redundancies are removed; and
performing inverse motion compensation on the frames in which the temporal redundancies have been removed using the merged motion vectors and unmerged base layer motion vectors.

29. The method of claim 28, further comprising readjusting the unmerged base layer motion vectors,
wherein the inverse motion compensation is performed on the frames in which the temporal redundancies have been removed using the merged motion vectors and the unmerged base layer motion vectors which have readjusted.

30. A video decoder comprising:
a bitstream interpreter which interprets an input bitstream and obtains texture information and motion information containing base layer motion vectors and enhancement layer motion vectors;
a motion vector readjuster which readjusts the base layer motion vectors;
an inverse quantizer which performs inverse quantization on the texture information;
an inverse spatial transformer which performs inverse spatial transform on the inversely quantized texture information to obtain frames in which temporal redundancies are removed; and
an inverse motion compensator which performs inverse motion compensation on the frames in which the temporal redundancies have been removed using the base layer motion vectors which have been readjusted and the enhancement layer motion vectors, and reconstructs a video frame.

31. The decoder of claim 30, wherein the motion vector readjuster readjusts the base layer motion vectors using enhancement layer motion vectors for neighboring blocks.

32. The decoder of claim 30, wherein the motion vector readjuster readjusts the base layer motion vectors using a predicted frame generated by the inverse motion compensator.

33. A video decoder comprising:
a bitstream interpreter which interprets an input bitstream and obtains texture information and motion information containing base layer motion vectors and residual motion vectors;
a motion vector merger which merges a base layer motion vector with a residual motion vector for each of a plurality of blocks having both the base layer motion vector and the residual motion vector, and obtains merged motion vectors;
an inverse quantizer which performs inverse quantization on the texture information;
an inverse spatial transformer which performs inverse spatial transform on the inversely quantized texture information and obtains frames in which temporal redundancies are removed; and
an inverse motion compensator which performs inverse motion compensation on the frames in which the temporal redundancies have been removed using the merged motion vectors and unmerged base layer motion vectors.

34. The decoder of claim 33, further comprising a motion vector readjuster readjusting the unmerged base layer motion vectors.

35. A recording medium having a computer readable program recorded therein, the program for executing a video coding method, the method comprising:
estimating a base layer motion vector and an enhancement layer motion vector for each block in a video frame;
removing temporal redundancies in the video frame using the enhancement layer motion vectors;
spatially transforming the video frame in which the temporal redundancies have been removed and quantizing the video frame which has been spatially transformed to obtain texture information;
selecting one of the base layer motion vector and the enhancement layer motion vector for each block; and
generating a bitstream containing the base layer motion vector or the enhancement layer motion vector selected for each block and the texture information.

36. A recording medium having a computer readable program recorded therein, the program for executing a video coding method, the method comprising:
estimating a base layer motion vector and an enhancement layer motion vector for each block in a video frame;
removing temporal redundancies in the video frame using the enhancement layer motion vectors;
spatially transforming the video frame in which the temporal redundancies have been removed and quantizing the video frame which has been spatially transformed to obtain texture information; and
generating a bitstream containing the base layer motion vector, a residual motion vector which is a difference between the base layer motion vector and the enhancement layer motion vector, and the texture information, for each block.

37. A recording medium having a computer readable program recorded therein, the program for executing a predecoding method, the method comprising:
receiving a bitstream containing a base layer motion vector, a residual motion vector which is a difference between the base layer motion vector and an enhancement layer motion vector for each block of a video frame, and texture information obtained by encoding the video frame, associated with each block in the video frame; and
truncating at least a part of the residual motion vectors.

38. A recording medium having a computer readable program recorded therein, the program for executing a video decoding method, the method comprising:
interpreting an input bitstream and obtaining texture information and motion information containing base layer motion vectors and enhancement layer motion vectors;
readjusting the base layer motion vectors;
performing inverse quantization and inverse spatial transform on the texture information to obtain frames in which temporal redundancies are removed; and
performing inverse motion compensation on the frames in which the temporal redundancies have been removed using the base layer motion vectors which have been readjusted and the enhancement layer motion vectors.

39. A recording medium having a computer readable program recorded therein, the program for executing a video decoding method, the method comprising:
interpreting an input bitstream and obtaining texture information and motion information containing base layer motion vectors and residual motion vectors;
merging a base layer motion vector with a residual motion vector for each of a plurality of blocks having both the base layer motion vector and the residual motion vector and obtaining merged motion vectors;
performing inverse quantization and inverse spatial transform on the texture information and obtaining frames in which temporal redundancies are removed; and
performing inverse motion compensation on the frames in which the temporal redundancies have been removed using the merged motion vectors and unmerged base layer motion vectors.
